(19) United States
(12) Patent Application Publication
(10) Pub. No.: US 2003/0079528 A1
(43) Pub. Date: May 1, 2003

(54) Method and apparatus for detecting non-contributing cylinders

(75) Inventor: William Wittliff, Gobles, MI (US)

Correspondence Address: BAKER + HOSTETLER LLP, WASHINGTON SQUARE, SUITE 1100, 1050 CONNECTICUT AVE. N.W., WASHINGTON, DC, 20036-5304, US

(73) Assignee: SPX Corporation

(21) Appl. No.: 10/174,825

(22) Filed: Jun. 20, 2002

Related U.S. Application Data
(60) Provisional application No. 60/330,753, filed on Oct. 30, 2001.

(51) Int. Cl. G01L 3/26

(52) U.S. Cl. 73/116

(57) ABSTRACT

A method and apparatus for detecting non-contributing cylinders in a reciprocating engine is provided. An accelerometer is attached to the engine and configured to generate a signal corresponding to cylinders firing in the engine. By comparing waveforms generated by a signal processor, it can be determined if a cylinder is not firing and which cylinder is not firing.

### PRIORITY

This application claims priority to provisional U.S. patent application entitled, CYLINDER BALANCE WITH ACCELEROMETERS, filed Oct. 30, 2001, having a serial No. 60/330,753, the disclosure of which is hereby incorporated by reference.

### FIELD OF THE INVENTION

The present invention relates generally to an apparatus and method for monitoring engine performance. More particularly, the present invention relates to a method and apparatus for using an accelerometer to determine whether cylinders are firing in a reciprocating engine.

### BACKGROUND OF THE INVENTION

Like any mechanical device, reciprocating engines, from time to time, experience mechanical failures. When an engine having a plurality of pistons and cylinders has a malfunction, such as a cylinder not firing, it may be possible for the engine to still run. (For the purpose of this document, malfunctioning cylinders may be referred to as non-firing, not firing, noncontributing and the like. Any of these terms is meant to describe a condition of when a cylinder does not contribute to the output of an engine as it should for whatever reason) However, adverse effects such as loss of revolutions per minute (RPM), lack of power, and loss of efficiency may result when a reciprocating engine experiences such a malfunction.

Therefore, engine operators and maintenance personnel have attempted to monitor the performance of an engine to ensure that all the pistons are firing. In order to perform diagnostic functions to determine if all cylinders and firing, several ways have been developed to monitor the firing of the cylinders in reciprocating engines.

One technique is to disable the ignition on each cylinder one at a time and measure drop in the RPM of the crank shaft. If a cylinder is non-functional or weak in its firing, the RPM for the crank shaft will drop in comparison to the RPM of the crank shaft when all cylinders are firing properly. If it is determined that one cylinder is not firing, the cylinders can be disabled one at a time and when disabling a certain cylinder causes no change in RPM, then the operator will have found the non-contributing cylinder.

While this technique may be effective in certain applications, it does have certain draw backs. For instance, this technique requires that the engines provide an access to the primary side of the ignition coil in order to selectively disable one of the cylinders from firing. While this type of access may be provided in certain older engines, newer vehicles may not provide easy access to the primary side of the ignition coil.

In addition, certain types of reciprocating engines, such as diesel engines, do not include the use of a spark plug to fire the cylinders. Because no spark plugs are used, many of these reciprocating engines do not have ignition coils, thus, making the technique of disabling the ignition coil not applicable to many reciprocating engines. Other engines which do include the use of ignition coils may not provide easy access to the ignition coil, and may be configured so that complex connections are required in order to disable certain cylinders. Therefore, it is desired that an apparatus and method be provided which is a non-intrusive, simple, method and apparatus for determining if an engine has a non-functional cylinder, and is applicable to a wide variety of reciprocating engines including both gasoline and diesel engines.

Accordingly, it is desirable to provide an apparatus and method for detecting which, if any, cylinder in a large variety of reciprocating engines is not firing.

### SUMMARY OF THE INVENTION

The above and other features and advantages are achieved through the use of a novel configuration and apparatus and method as herein disclosed.

It is therefore a feature and advantage of the present invention to provide an apparatus and method for determining whether a cylinder is not firing that is applicable for a wide range of reciprocating engines including both gasoline and diesel engines.

It is another feature and advantage of the present invention to provide an apparatus and method to determine which cylinder is not firing.

The above and other features and advantages are achieved through the use of a novel apparatus and method as herein disclosed. In accordance with one embodiment of the present invention, an apparatus for detecting a non-contributing cylinder in a reciprocating engine is provided. The apparatus includes an apparatus for detecting a non-contributing cylinder in a reciprocating engine comprising an accelerometer mounted to the engine, and configured to generate a signal corresponding to cylinders firing within the engine.

In accordance with one embodiment of the present invention, an apparatus for detecting a non-contributing cylinder in a reciprocating engine is provided. The apparatus includes means for detecting accelerations corresponding to cylinders firing in the engine mounted to the engine, and configured to generate a signal corresponding to cylinders firing within the engine.

In accordance with another embodiment of the present invention a method for detecting a non-contributing cylinder in a reciprocating engine is provided. The method includes attaching an accelerometer to the engine, generating a signal with the accelerometer, transmitting the signal to a signal processor, analyzing an output from the signal processor corresponding to the signal.

There has thus been outlined, rather broadly, the more important features of the invention in order that the detailed description thereof that follows may be better understood, and in order that the present contribution to the art may be better appreciated. There are, of course, additional features of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 illustrates an exemplary embodiment of the present invention showing an accelerometer attached to a motor and a computer for detecting a non-contributing cylinder within the engine.

FIG. 2 is a plot of a waveform generated by an accelerometer attached to an engine as in FIG. 1 for a Dodge 3.0 liter V6 with all cylinders firing.

FIG. 3 is a plot of a waveform generated by an accelerometer configured as shown in FIG. 1 for a Dodge 3.0 liter V6 with a number three cylinder not firing.

FIG. 4 is a plot of a waveform generated by an accelerometer as configured as shown in FIG. 1 for a Dodge 3.0 liter V6 with a number six cylinder not firing.

### DETAILED DESCRIPTION OF PREFERRED EMBODIMENTS OF THE INVENTION

A preferred embodiment of the present invention provides an apparatus and method for detecting whether a cylinder within a reciprocating engine is not firing. In some optional embodiments, the method and apparatus may detect which cylinder is not firing out of group of cylinders associated with the reciprocating engine.

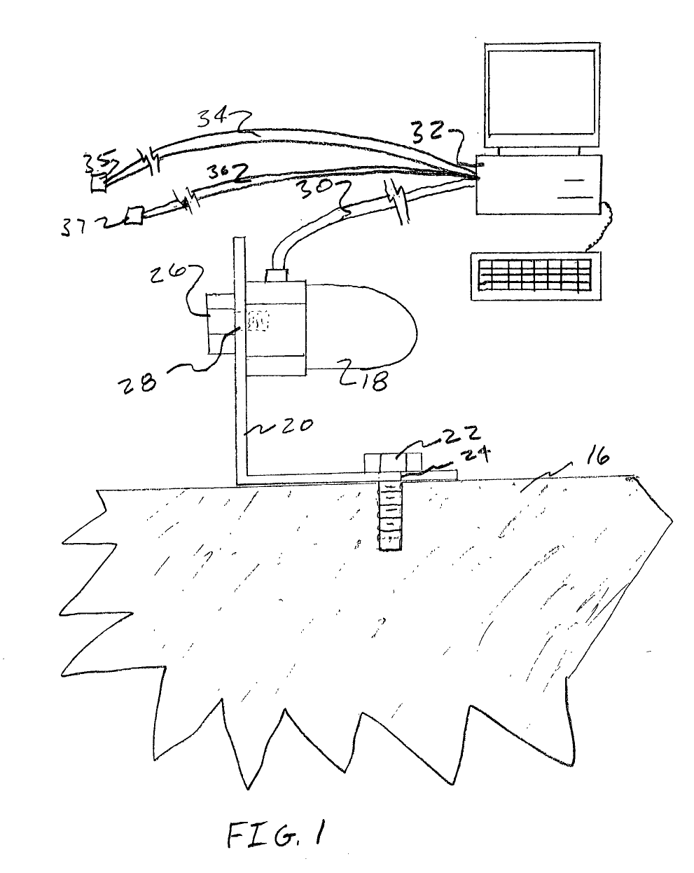

Referring now to the figures, where like reference numerals indicate like elements, FIG. 1 illustrates an exemplary embodiment of an apparatus used to detect whether an engine has a non-functional cylinder. In the embodiment shown in FIG. 1 the apparatus includes an accelerometer 18 mounted by an angle bracket 20 to an engine 16. The bracket 20 is secured to the engine 16 by a bolt 22 bolted through a hole 24 in the bracket 20. It may not be necessary to drill new holes in an engine block 16 in order to secure the bracket 20. Rather, bolt holes already existing in the engine block 16 may be used.

Some examples of places where the bracket 20 may be mounted on an engine include holes already existing in the engine 16 on the throttle body mount, and on valve covers. The accelerometer 18 may be secured to the angle bracket 20 by a bolt 26 extending through bolt hole 28 in the angle bracket 20 to the accelerometer 18. While the embodiment shown in FIG. 1 illustrates the accelerometer 18 bolted to an angle bracket 20 that is bolted to the engine block 16, other embodiments of the invention may include fastening the accelerometer 18 directly to the engine 16 or to some other type of mounting apparatus in a way that does or does not necessarily require bolts.

In FIG. 1, the accelerometer 18 is attached to the computer 32 by a cord 30. Voltages generated by the accelerometer 18 are sent to the computer 32 via the cord 30. The computer 32 uses a filter to filter the signals generated by the accelerometer 18. Optionally, the computer 32 may have interface software loaded on it. For example one embodiment of the invention may use LabVIEW™ software made by National Instruments Corp. Software such as LabVIEW™ which may include a filter configured to filter out high frequencies generated by the accelerometer attached to an engine block 16 thus making the signal sent to the computer 32 easier to read. In addition to the software, the computer 32 may also include data acquisition hardware to generate graphical representations of waveforms corresponding to voltages sent to the computer 32 generated by the accelerometer 18. An example of the data acquisition hardware may include a data acquisition board installed in a personal computer such as a National Instruments Corp. ATMIO 16X.

While a variety of accelerometers may be used, some embodiments of the invention may include using an ENDEVCO accelerometer model 2242C, the sensitivity of which may be 10 mV per G. In order to amplify the signal generated by the accelerometer 18, an amplifier may be used. The amplifier may be any number of amplifiers used on the market. For example, it may be an ENDEVCO Corp. model 6630. While certain and particular hardware are described herein, the invention is certainly not limited to apparatus or methods including these specific elements. Any similar elements configured as described herein are in accordance with the invention.

For best results, mounting the accelerometer 18 perpendicular to the rotation of the crank shaft is recommended. In addition, mounting the accelerometer 18 closer to the crank shaft may also improve results. Every time a piston in the engine 16 fires, it accelerates the crank shaft. The accelerometer 18, when mounted as described herein, detects an acceleration in the engine as the pistons accelerate the crank shaft. When a cylinder does not fire, the acceleration normally associated with that cylinder firing is absent, and the crank shaft slows down. The next cylinder to fire, after the one which did not fire, then fires. The firing of the next cylinder creates a larger than normal acceleration on the crank shaft. Both of these phenomena, that of an absence of acceleration on the crank shaft followed by an extra ordinary large amount acceleration on the crank shaft, are detected by the accelerometer 18.

Optionally, some embodiments of the invention may include one or more additional sensors 35, 37. Sensor 35 may be connected to the computer 32 via a cable 34 for transmitting the sensor's signal to the computer 32. Sensor 35 may be used to determine the firing of a specific cylinder in the engine 16. This specific cylinder may be considered the base, or number one cylinder. By comparing when this cylinder fires and the slow down of the crank shaft followed by the large acceleration in the crank shaft, the specific cylinder that is not firing can be determined, as explained more fully later below.

In gasoline powered engines, sensor 35 may be an inductive pick sensor configured to detect when a spark plug processes a charge. In diesel engines, sensor 35 may be a strain gage configured to detect a fluid pulse of when fuel is pulsed into a cylinder. Either of these types of events, a spark plug processing a charge or a fuel pulse, are useful for determining when a cylinder fires. Once it is determined when the number one cylinder fires, the noncontributing cylinder can be determined, as explained later below.

Optionally, some embodiments of the invention may include a sensor 37. Sensor 37 may be connected to the computer 32 via a cable 36 for transmitting the sensor's signal to the computer 32. Sensor 37 may be attached to the ignition coil and sense when the spark plugs are given currents to allow the spark plugs to fire. This information may be used to determine when the cylinders fire, and as explained more fully below, may be used to determine which cylinder is not firing. These types of sensors the are known in the art and will not be described in detail herein.

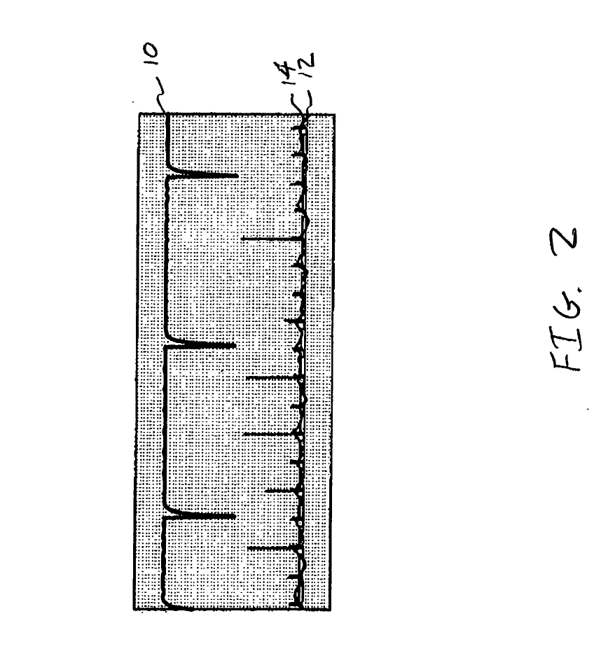

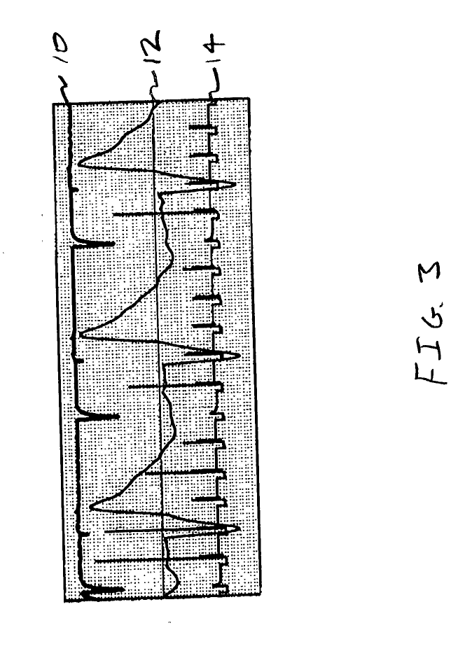

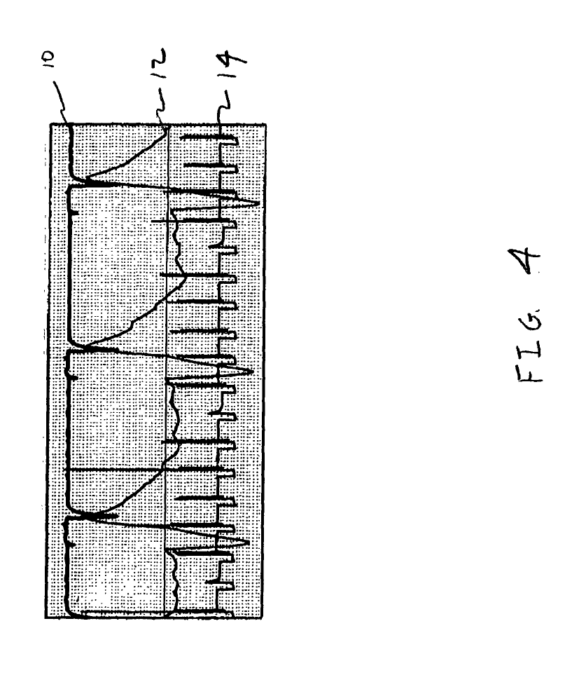

FIGS. 2, 3 and 4 are drawings of waveforms generated by a computer 32 corresponding to signals sent to the computer 32 by an accelerometer 18 and sensors 35 and 36. The waveform shown in FIGS. 2-4 are exemplary of what an accelerometer 18, and the sensors 35 and 37 may detect in an engine. FIGS. 2-4 show three waveforms generated on the same plot. The first waveform 10 indicates an acceleration associated with the firing of the first or number one cylinder. The second waveform 12 shows accelerations detected by the accelerometer and waveform 14 indicates voltages detected by the primary ignition. These voltage spikes illustrate when the spark plugs are given charges for firing. The particular waveforms in FIGS. 2-4 were generated by accelerometer 18 and sensors 35, 36 attached to a 1990 Dodge 3.0 liter V6. However, the same apparatus and method can be applied to other types of reciprocating engines with similar results. FIG. 2 shows waveforms generated when all cylinders are functioning. FIG. 3 shows waveforms generated when the number three cylinder does not fire and FIG. 4 shows the waveforms generated when the number six cylinder does not fire.

In FIG. 2 the accelerometer data detected by the accelerometer waveform 14 is somewhat consistent showing minor variations associated with accelerations when each piston fires and accelerates the crank shaft.

In FIG. 3 the number three cylinder is not firing. The waveform 12 starts off (from left to right) showing a somewhat flat area as an engine is running normally. A deceleration is shown as the crank shaft does not receive an acceleration from the number three cylinder that does not fire. As the next cylinder after the number three cylinder fires, there is a rapid acceleration followed by a deceleration and a return to normal state. About midway down the graph, the waveform 12 repeats as it again shows a dramatic deceleration with an increased acceleration. As mentioned above these are indicators of the cylinder not firing.

As shown in FIG. 3, the next cylinder to fire, as indicated by the rapid acceleration following a deceleration of waveform 12, occurs directly in between firings of cylinder one. The anomaly in waveform 12 occurring directly in the midpoint of indications of firing of cylinder one as indicated by waveform 10 indicates that it is a number three cylinder that is not firing shown in FIG. 3.

FIG. 4 shows a similar waveform number 12 as in FIG. 3, except the waveform 12 has shifted. By comparing waveform 12 with waveform 10, (waveform 10 being the baseline of the number one cylinder firing) it can be determined which cylinder is not firing. As shown in FIG. 4, the first sharp dip in the number 10 waveform (reading the waveform 10 from left to right) indicates when the number one cylinder fires. This firing of the number one cylinder, as shown in waveform 10, corresponds with the rapid acceleration indicated in waveform 12. This indicates that it is the number one cylinder which fires immediately after the non-contributing cylinder because the number one fires directly after the number six cylinder. It may be determined that because the engine being compared in FIG. 4 is a six cylinder engine, that it is the number six cylinder that is not firing.

While these figures show waveforms for a V6 engine, similar analysis can be used in other cylinder configurations, such as, four cylinder engines, inline six cylinder engines, V8 engines, V10, V12 and other configurations. The cylinder which is not firing can be determined by comparing the acceleration data waveform 12 with the firing of the number one cylinder waveform 10. Comparing where the cylinder does not fire shown by waveform 12 in comparison to the firing of the first cylinder indicated by waveform 10 is one way to determine which cylinder does not fire.

In some embodiments of the invention another way of determining which cylinder is not firing is provided. An optional waveform 14 is provided by connecting a sensor 37 to the primary ignition module or engines which has a primary ignition. Waveform 14 is generated by a primary ignition. When the primary ignition sends a voltage to the spark plug, this indicates a time of firing. This ignition signal also sends a voltage to the computer 32 via the sensor 37 attached to the primary ignition. This voltage is plotted by the computer 32 as waveform 14. In reviewing the plots of FIGS. 2-4, the variations in the waveform 14 indicate when the signal was sent for the cylinders to fire. By comparing waveform 12 data received by the accelerometer 18 to when the cylinder should have fired as dictated by the primary ignition, an operator can determine whether a cylinder is not firing.

As shown in FIG. 3 (starting from left to right), the first drop off in the acceleration of waveform 12 corresponds with the signal from the primary ignition waveform 14 showing when the primary ignition sends a signal for firing. This indicates that the primary ignition did send a signal for that piston to fire and the piston failed to fire.

Thus the apparatus and method disclosed provides a diagnostic technique for determining if and which cylinders are not firing.

The many features and advantages of the invention are apparent from the detailed specification, and thus, it is intended by the appended claims to cover all such features and advantages of the invention which fall within the true spirits and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. An apparatus for detecting a non-contributing cylinder in a reciprocating engine comprising:
an accelerometer mounted to the engine, and configured to generate a signal corresponding to cylinders firing within the engine.

2. The apparatus of claim 1, further comprising a signal processing device operably connected to the accelerometer configured to display a waveform corresponding to the signal generated by the accelerometer.

3. The apparatus of claim 2, further comprising a sensor operably connected to the signal processing device, and configured to generate a signal corresponding to at least one a firing of a spark plug and a fuel pulse delivered to a specific cylinder wherein the signal processing device is configured to display a waveform associated with the signal generated by the sensor comparable to the waveform corresponding to the signal generated by the accelerometer.

4. The apparatus of claim 2, further comprising a sensor operablely connected to the signal processing device, and configured to generate a signal corresponding to a primary ignition wherein the signal processing device is configured to display a waveform associated with the signal generated by the sensor comparable to the waveform corresponding to the signal generated by the accelerometer.

5. The apparatus of claim 1, further comprising a bracket attached to the engine, wherein the accelerometer is attached the bracket.

6. The apparatus of claim 5, wherein the bracket is bolted to the engine via at least one hole in the engine.

7. The apparatus of claim 1, wherein the accelerometer is mounted substantially orthogonal to a direction of rotation of a crankshaft associated with the engine.

8. The apparatus of claim 2, wherein the signal processing device is at least one of a computer, a hand held device, and a mirco-processor.

9. The apparatus of claim 2, wherein the signal processing device is configured to display the waveform by at least one of printing the waveform and displaying the waveform on a screen.

10. An apparatus for detecting a non-contributing cylinder in a reciprocating engine comprising:
means mounted to the engine for detecting accelerations corresponding to cylinders firing in the engine and
means for generating a first signal corresponding to cylinders firing within the engine.

11. The apparatus of claim 10, further comprising means for processing the first signal and means for displaying a waveform corresponding to the first signal.

12. The apparatus of claim 11, further comprising:
means for sensing at least one of a firing of a spark plug and a fuel pulse delivered to a specific cylinder, the means for sensing operablely connected to the processing means;
means for generating a second signal corresponding to at least one of a firing of a spark plug and a fuel pulse delivered to a specific cylinder; and
means for displaying a waveform associated with signal generated by the sensing means comparable to the waveform corresponding to the signal generated by the detecting means.

13. The apparatus of claim 11, further comprising:
means for sensing a primary ignition, the means for sensing operablely connected to the processing means;
means for generating a third signal corresponding to a primary ignition; and
means for displaying a waveform associated with signal generated by the sensing means comparable to the waveform corresponding to the signal generated by the detecting means.

14. The apparatus of claim 10, further comprising a bracket attached to the engine, wherein the detecting means is attached the bracket.

15. The apparatus of claim 14, wherein the bracket is bolted to the engine via at least one hole in the engine.

16. The apparatus of claim 10, wherein the detecting means is mounted substantially orthogonal to a direction of rotation of a crankshaft associated with the engine.

17. The apparatus of claim 11, wherein the processing means is at least one of a computer, a hand held device, and a mirco-processor.

18. The apparatus of claim 11, wherein the displaying means displays the waveform by at least one of printing the waveform and displaying the waveform on a screen.

19. A method of detecting a non-contributing cylinder in a reciprocating engine comprising:
attaching an accelerometer to the engine;
generating a first signal with the accelerometer;
transmitting the signal to a signal processor; and
analyzing an output from the signal processor corresponding to the signal.

20. The method of claim 19, further comprising generating a waveform corresponding to the signal.

21. The method of claim 20, wherein analyzing the output from the signal processor includes displaying the waveform and determining at least one of whether a cylinder is not firing and which cylinder is not firing.

22. The method of claim 19, further comprising generating a second signal corresponding to at least one of a spark plug firing and a fuel pulse delivered to a specific cylinder and sending the second signal to the signal processor.

23. The method of claim 22, further comprising generating waveforms corresponding to the first signal and the second signal and comparing the waveforms to determine which cylinder is not firing.

24. The method of claim 19, further comprising generating a third signal corresponding to a primary ignition and sending the third signal to the signal processor.

25. The method of claim 24, further comprising generating waveforms corresponding to the first signal and the third signal and comparing the waveforms to determine which cylinder is not firing.
